(19) United States
(12) Patent Application Publication
(10) Pub. No.: US 2017/0210963 A1
(43) Pub. Date: Jul. 27, 2017

(54) Cooling Solutions and Compositions for Rapid Chilling Foods and Beverages and Methods of Making

(71) Applicant: Supercooler Technologies, Inc., Maitland, FL (US)

(72) Inventors: Douglas Shuntich, Maitland, FL (US); Edward T. Gladstone, Canton, OH (US)

(21) Appl. No.: 15/480,567

(22) Filed: Apr. 6, 2017

Related U.S. Application Data
(63) Continuation-in-part of application No. 14/298,117, filed on Jun. 6, 2014.
Application No. 14/298,117 is a continuation-in-part of application No. 14/163,063, filed on Jan. 24, 2014, now Pat. No. 9,631,856.
(60) Provisional application No. 61/966,106, filed on Feb. 18, 2014.

(51) Int. Cl. C09K 5/10; F25D 31/00

(52) U.S. Cl. CPC C09K 5/10; F25D 31/007

(57) ABSTRACT

Cooling solutions and liquid compositions for rapid chilling of foods, desserts and beverages and methods and processes for making the cooling solutions and compositions, where the solutions and liquid compositions are chilled in a refrigerated holding tank until a set temperature is reached followed by moving covered foods, desserts and containers holding beverages that are immersed into the tank, and subsequently evenly chilled to a selected temperature. Precisely controlled and evenly distributed temperature (within a few degrees Fahrenheit) can be obtained within the novel cooling solution and liquid composition.

This application is a Continuation-In-Part of U.S. patent application Ser. No. 14/298,117 filed Jun. 6, 2014, which claims the benefit of priority to U.S. Provisional Application Ser. No. 61/966,106 filed Feb. 18, 2014, and this application is a Continuation-In-Part of U.S. patent application Ser. No. 14/163,063 filed Jan. 24, 2014. The entire disclosure of each of the applications listed in this paragraph are incorporated herein by specific reference thereto.

### FIELD OF INVENTION

This invention relates to cooling solutions, and in particular to cooling solutions and liquid compositions for rapid chilling of foods, desserts and beverages and methods and processes for making the cooling solutions and compositions, where the solutions and liquid compositions are chilled in a refrigerated holding tank until a set temperature is reached followed by moving covered foods, desserts and containers holding beverages that are immersed into the tank, and subsequently evenly chilled to a selected temperature.

### BACKGROUND AND PRIOR ART

Packaged-ice, such as different weights of bagged ice has been popular to be used in portable coolers to chill canned and bottled beverages. Packaged-ice has generally become standardized over the past decades with a few popular sizes in the U.S. and around the world dominating the sales. For example, the 10 lb bag of packaged-ice is the most popular retail version of packaged-ice in the U.S., followed in descending popularity by 20 lb, 8 lb, 7 lb and 5 lb bags of packaged-ice.

In Canada, the United Kingdom(UK), and other European countries, other standard sizes such as but not limited to 6 lb (2.7 kg), and 26.5 lb (12 kg) are also very popular forms of packaged-ice.

The bags of packaged-ice generally comprise loose ice cubes, chips and the like, that are frozen fresh water. The standard use of the bags of ice is having the consumer place the bag(s) loosely in cooler containers, and then adding canned and/or bottled beverages, such as sodas, waters to the coolers containing the packaged-ice.

Due to the melting properties of the fresh-water ice, canned and bottled beverages placed in ice cannot be chilled below 32 degrees Fahrenheit for any significant length of time, which is the known general freezing point.

Over the years, the addition of ice-melters such as salt have been known to be used to lower the melting point of fresh-water ice. Forms of using salt have included sprinkling loose salt on packed-ice in a cooler to produce lower temperatures for certain canned and bottled beverages placed inside. Sprinkling salt has been tried with beer, since beer will not freeze at 32 degrees due to its alcohol content. However, the use of sprinkling loose salt has problems.

Due to the uneven spread of salt on ice, it is impossible to know or control precisely the resulting temperate below 32 degrees on various ice-cubes in the cooler obtained by sprinkling of salt. Salt sprinkling has inevitably resulted in some of the beverages “freezing hard” while others remain liquid and sometimes at temperatures above 32 degrees. As such, the spreading of salt or other ice-melters on packaged-ice in a cooler to obtain colder temperatures than 32 degrees is an impractical method to know and control precisely the resulting temperature of ice-cubes in a cooler environment.

Some recent trends in custom cold beverage creation at home and at commercial establishments rely on traditional refrigeration and/or placing ice inside the beverage to obtain cold temperatures. At home custom beverage creating devices such as SODASTREAM® by Soda-Club (CO2) Atlantic GmbH, and KEURIG COLD™ by Keurig Green Mountain Inc. each rely on one of these traditional methods for cooling, and each of these devices having significant drawbacks.

Traditional refrigeration offers a relatively slow and inefficient method of cooling, requiring hours to obtain approximately 40 F drinking temperatures.

Placing ice inside a beverage, while providing very rapid cooling and ‘ice-cold’ temperature, has the drawbacks of; 1) watered-down flavoring, 2) introducing impurities, and 3) causing premature de-carbonation of carbonated beverages.

The non-traditional method of cooling canned and bottled beverages rapidly by spinning then on their longitudinal axis while the can or bottle is in contact with ice or ‘ice-cold’ liquid (usually fresh water at or near approximately 32 deg-F) has also been attempted. See for example, U.S. Pat. No. 5,505,054 to Loibl et al. This patent describes a rapid beverage cooling method and device that attempts to reduce beverage cooling times from hours to close to a minute without putting ice in the beverage.

It has been known for many years that alcoholic and non-alcoholic bottled and canned beverages of all varieties, including bottled water, can be super cooled below 32 deg-F while remaining liquid for short periods of time. What is not generally known is how to cool these beverages rapidly to precise super cooled temperatures which allow for enjoyable ‘slush-on-demand’ drinking experiences while preventing unwanted or premature freezing which can result in undesirable effects such as 1) premature foaming or release of carbonation in an undesirable way, and 2) hard frozen or ‘chunky’ frozen beverages which are difficult to consume.

The prior art does not supercool beverages below 32-degrees and/or below their own freezing point while keeping them in a liquid state to allow for previously impossible beverages, such as creating instant milkshakes from super cooled milk beverages and creating instant smoothies from super cooled fruit and vegetable juices without using chopped-ice inserted into the liquid drink.

The prior art does not allow for precision temperature control at below freezing temperatures required to produce the desired effects rapidly and make them sustainable over periods of time.

Thus, the need exists for solutions to the above problems with the prior art.

### SUMMARY OF THE INVENTION

A primary objective of the present invention is to provide cooling solutions and liquid compositions for rapid chilling of foods, desserts and beverages where the solutions and liquid compositions are chilled in a refrigerated holding tank until a set temperature is reached followed by moving covered foods, desserts and containers holding beverages to be immersed in the tanks, and subsequently chilled to a selected temperature in a short time spans.

A secondary objective of the present invention is to provide methods and processes for making the cooling solutions and compositions, where the solutions and liquid compositions are chilled in a refrigerated holding tank until a set temperature is reached followed by moving covered foods, desserts and containers holding beverages to be immersed into the tank, and subsequently chilled to a selected temperature in a short time span.

A third objective of the present invention is to provide cooling solutions and liquid compositions for evenly chilling of foods, desserts and beverages and methods and processes for making the cooling solutions and compositions, where the solutions and liquid compositions are chilled in a refrigerated holding tank until a set temperature is reached followed by moving covered foods, desserts and containers holding beverages that are immersed into the tank, and subsequently evenly chilled to a selected temperature.

A fourth objective of the present invention is to provide cooling solutions and liquid compositions for rapid chilling of foods, desserts and beverages and methods and processes for making the cooling solutions and compositions, where the solutions and liquid compositions are chilled in a refrigerated holding tank until a set temperature is reached followed by moving covered foods, desserts and containers holding beverages that are immersed into the tank, and subsequently chilled to a selected temperature to allow for enjoyable ‘slush-on-demand’ drinking experiences while preventing unwanted or premature freezing which can result in undesirable effects such as 1) premature foaming or release of carbonation in an undesirable way, and 2) hard frozen or ‘chunky’ frozen beverages which are difficult to consume.

A fifth objective of the present invention is to provide cooling solutions and liquid compositions for rapid chilling of foods, desserts and beverages and methods and processes for making the cooling solutions and compositions, where the solutions and liquid compositions are chilled in a refrigerated holding tank until a set temperature is reached followed by moving covered foods, desserts and containers holding beverages that are immersed into the tank for keeping the beverages, foods and desserts chilled for extended lengths of time(greater than approximately 12 to approximately 24 hours) without using an external power supply source such as electricity or fuel, below freezing. The extended periods of time are beneficial for transporting food, dessert and beverage items that take a long time to transport.

A liquid composition for use with rapidly chilling beverage containers, can include or can consist of deionized water, magnesium chloride, magnesium citrate, and vegetable glycerin, wherein the composition is useful as pre-chilled liquid mixture for rapidly chilling beverage containers.

The liquid composition of claim 1, can include a taste modifier, that can include Stevia RebA Aspartane.

The liquid composition can include a defoamer concentrator, that can include xiameter.

The liquid composition can include approximately 60% to approximately 80% deionized water, approximately 10% to approximately 30% magnesium chloride, less than approximately 1% magnesium citrate, and less than approximately 5% vegetable glycerin.

The liquid composition can include approximately 70% to approximately 80% deionized water, approximately 15% to approximately 25% magnesium chloride, less than approximately 0.5% magnesium citrate, and less than approximately 2.5% vegetable glycerin.

The liquid composition can include approximately 78.9476 deionized water, approximately 20.6064 magnesium chloride, less than approximately 0.0310% magnesium citrate, and less than approximately 1.2214% vegetable glycerin.

The liquid composition can include less than approximately 5% taste modifier, and less than approximately 5% defoamer concentrator.

The liquid composition can include less than approximately 2.5% taste modifier, and less than approximately 2.5% defoamer concentrator.

A method of mixing a chilling coolant for beverage containers, can include the steps of providing a first vessel, adding a first batch of deionized water to the first vessel, mixing magnesium chloride with the deionized water to form a first homogenous mixture, allowing the first homogenous mixture to de-aerate in the main vessel, providing a second vessel, adding a second batch of deionized water to the second vessel, heating and mixing the deionized water in the second vessel. mixing magnesium citrate into the second vessel to form a second homogenous mixture, allowing the second homogenous mixture to de-aerate in the second vessel and mixing the second homogenous mixture and the first homogenous mixture together until the two mixtures are homogenous in a combined mixture.

The method can include the steps of mixing additional materials into the combined mixture, and allowing the combined mixture mixed with the added addition materials to de-aerate and cool to room temperature.

The additional materials can be selected from at least one of a taste modifier and a defoamer concentrator.

The taste modifier can include Stevia RebA Aspartane. The defoamer concentrator can include xiameter.

Further objects and advantages of this invention will be apparent from the following detailed description of the presently preferred embodiments which are illustrated schematically in the accompanying drawings.

### BRIEF DESCRIPTION OF THE FIGURES

FIG. 1 is a flow chart showing the overall steps for making the novel solution and composition.

### DESCRIPTION OF THE PREFERRED EMBODIMENTS

Before explaining the disclosed embodiments of the present invention in detail it is to be understood that the invention is not limited in its applications to the details of the particular arrangements shown since the invention is capable of other embodiments. Also, the terminology used herein is for the purpose of description and not of limitation.

In the Summary above and in the Detailed Description of Preferred Embodiments and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, that feature can also be used, to the extent possible, in combination with and/or in the context of other particular aspects and embodiments of the invention, and in the invention generally.

In this section, some embodiments of the invention will be described more fully with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will convey the scope of the invention to those skilled in the art. Like numbers refer to like elements throughout, and prime notation is used to indicate similar elements in alternative embodiments.

The present invention will now be described more fully hereinafter with reference to the accompanying drawings, in which preferred embodiments of the invention are shown. Unless otherwise defined, technical and scientific terms used herein have the same meaning as commonly understood by one of ordinary skill in the art to which this invention pertains. Although methods and materials similar or equivalent to those described herein can be used in the practice or testing of the present invention, suitable methods and materials are described below.

Any publications, patent applications, patents, and other references mentioned herein are incorporated by reference in their entirety. In case of conflict, the present specification, including any definitions, will control. In addition, the materials, methods and examples given are illustrative in nature only and not intended to be limiting. Accordingly, this invention may be embodied in many different forms and should not be construed as limited to the illustrated embodiments set forth herein. Rather, these illustrated embodiments are provided solely for exemplary purposes so that this disclosure will be thorough and complete, and will fully convey the scope of the invention to those skilled in the art. Other features and advantages of the invention will be apparent from the following detailed description and from the claims.

The subject application is a Continuation-In-Part of U.S. patent application Ser. No. 14/298,117 filed Jun. 6, 2014, which claims the benefit of priority to U.S. Provisional Application Ser. No. 61/966,106 filed Feb. 18, 2014, and this application is a Continuation-In-Part of U.S. patent application Ser. No. 14/163,063 filed Jan. 24, 2014. The entire disclosure of each of the applications listed in this paragraph are incorporated herein by specific reference thereto.

The novel invention can be used as the cooling liquid medium referenced in U.S. Patent Application Serial No. U.S. patent application Ser. No. 14/298,117 filed Jun. 6, 2014, which claims the benefit of priority to U.S. Provisional Application Ser. No. 61/966,106 filed Feb. 18, 2014.

In a preferred embodiment, the novel chilling solutions and liquid compositions can be used in a tank that has been chilled to between approximately −40 F to approximately +30 F. Cooling of the tank can be done with refrigerators shown and described in reference to U.S. Patent Application Serial No. U.S. patent application Ser. No. 14/298,117 filed Jun. 6, 2014, which claims the benefit of priority to U.S. Provisional Application Ser. No. 61/966,106 filed Feb. 18, 2014, which are both incorporate by reference in their entirety.

TABLE 1 provides the novel components and amounts of the liquid solution and composition that can be used.

| Component | Broad Range | Narrow Range | Preferred % |
|---|---|---|---|
| DI | Approx. 60 to | Approx. 70 to | 78.9476 |
| (deionized) | approx. 80% | approx. 80 | |
| Water | | | |
| MgCl2 | Approx. 10 to | Approx. 15 to | 20.6064% |
| Magnesium | Approx. 30% | approx. 25% | |
| chloride | | | |
| Magnesium | <approx. 1% | <approx. 0.5% | 0.0310% |
| Citrate | | | |
| Vegetable | <approx. 5% | <approx. 2.5% | 1.2214% |
| glycerin | | | |
| Taste | <approx. 5% | <2.5% | 0% |
| Modifier | | | |
| Defoamer | <approx. 5% | <approx. 2.5% | 0% |
| Concentrator | | | |

Referring to TABLE 1, the taste modifier can include but is not limited to stevia RebA Aspartane, monk fruit, dextrose, maltodextrin and the like.

The defoamer concentrator can include but is not limited to xiameter, and the like. Other types of defoamer concentrators can include but are not limited to anti-foam emulsion food grade concentrators, and silicon based defoamer concentrators, such as water and a surfactant (for example, nonethythoxy) or nonionic surfactant.

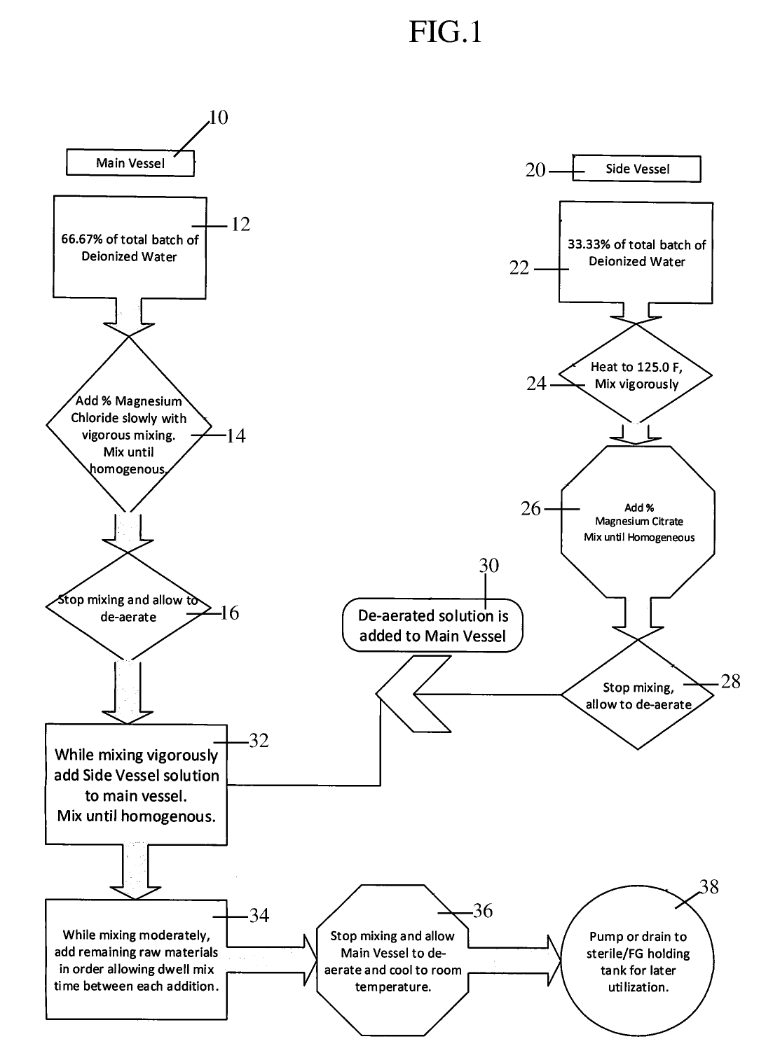

FIG. 1 is a flow chart showing the overall steps for making the novel solution and composition. The invention can start with a large main vessel type container 10 and a side vessel container.

Starting with the main vessel 10, approximately 66.67% (⅔) of an total batch of deionized water 12 can poured into the main vessel 10. Next, a percent of magnesium chloride (as referenced in Table 10) 14 can be added slowly into the main vessel with vigorous mixing until the mixed solution becomes homogenous. For example, for a batch of up to approximately 1,000 pounds, it can take up to approximately 15 minutes to approximately 30 minutes time to mix.

After a homogenous mixture is achieved, the mixing is stopped and the mixture is allowed time to de-aerate 16. For example, for a batch of up to approximately 1,000 pounds, it can take up to approximately 30 minutes up to approximately 90 minutes to de-aerate.

In a side vessel 20, approximately ⅓ (33.33%) of a total batch of deionized water 22 is poured into the side vessel 20. The side vessel 20 is then heated to approximately 125 F while mixing vigorously 24. For example, for a batch of up to approximately 1,000 pounds, it can take up to approximately 30 minutes up to approximately 60 minutes to heat.

Next, a percent of magnesium citrate (see Table 1) is mixed in and continued to be mixed until the mixture becomes homogeneous 26. For example, for a batch of up to approximately 1,000 pounds, it can take up to approximately 30 minutes up to approximately 60 minutes to mix.

After a homogenous mixture is achieved, the mixing is stopped and the mixture is allowed time to de-aerate 28. For example, for a batch of up to approximately 1,000 pounds, it can take up to approximately 30 minutes up to approximately 90 minutes to de-aerate.

The de-aerated solution is then added to the main vessel 30.

While mixing vigorously, the side vessel solution is added to the main vessel 10 and continued to be mixed until the mixture becomes homogenous 32. For example, for a batch of up to approximately 1,000 pounds, it can take up to approximately 60 minutes up to approximately 60 minutes to mix.

While mixing moderately (light mixing without creating a vortex), the remaining raw materials (such as vegetable glycerin, defoamer concentrator and a taste modifier can be added in this order), referenced in TABLE 1 is added in order allowing a dwell mix time between each addition 34. The dwell mix time between adding each raw material can be approximately 5 to approximately 10 minutes. For example, for a batch of up to approximately 1,000 pounds, it can take up to approximately 45 minutes up to approximately 60 minutes to mix moderately.

Next, mixing is stopped, and the solution in the main vessel 10 is allowed to de-aerate and cool to room temperature 36. For example, for a batch of up to approximately 1,000 pounds, it can take up to approximately 120 minutes up to approximately 180 minutes to de-aerate.

The final step 38 is to pump or drain the solution to a sterile/FG (food grade) holding tank to be used later.

Referring to the above steps for small batches of less than approximately 1,000 pounds, mixing can be done by hand paddle or stir rod. For larger batches, mixing can be done by a powered food grade mixer.

For a total batch of approximately 3 gallons, one can start with approximately 2 gallons of deionized water in main vessel 10, and start with approximately 1 gallon of deionized water in side vessel 20.

In a preferred embodiment, a batch of the novel solution, can be pre-chilled in a refrigerator until a temperature of approximately 32 F to approximately 50 F Is achieved.

A refrigerated holding tank such as a refrigerator container can have a temperature of between negative 40 F to 30 F, and not above this amount for vortex immersions.

The batch can be cooled for up to approximately 12 hours.

Next, beverage containers can be immersed into the chilled liquid solution, and rapidly chilled using techniques described for example, in U.S. patent application Ser. No. 14/298,117 filed Jun. 6, 2014, which claims the benefit of priority to U.S. Provisional Application Ser. No. 61/966,106 filed Feb. 18, 2014. Such techniques can include alternatively rapid spinning the beverage containers in different directions.

For example, starting at a room temperature of approximately 75 F (approximately 24.0 C) using a prototype of a preferred embodiment of the present invention rotating at up to approximately 2500 rpm (which can include over approximately 2500 rpm) and switching directions every 0.65 seconds (which can include approximately 0.65 seconds). The term approximately can include +/−10%.

With the pre-chilled solution, the beverage containers can be rapidly chilled to temperatures of approximately 10 F to approximately 34 F, or evenly be slightly chilled to below room temperature to approximately 60 F.

The contents can be chilled to these low temperatures in seconds.

The invention can be used with various types of beverage containers, such as but not limited to canned and bottled beverages (between 8 oz, 12 oz and 16 oz). The bottles can include glass as well as plastic bottles. The cans can include aluminum cans, and the like.

The beverage containers can also include larger beverage containers, such as but not limited to 48 oz, 1 gallon, two gallons, 1 liter, 1.5 liters and 3 liter plastic and glass bottles, and the like.

The contents of the beverage containers can include carbonated beverages, such as soda pop, beer, and the like, as well as any type of uncarbonized beverage, such as but not limited to fruit juices, flavored waters, alcohol and non-alcoholic drinks, and the like.

Optional buffering additives, can also be used in the solution, such as but not limited to vegetable derivatives, such as vegetable glycerin or vegetable glycerol, food coloring, propylene glycol, flavorings, sweeteners, and the like, and any combinations thereof.

In addition, an optional deterrent additive(s) such as but not limited to Alum, extract of Lemon, orange, lime, and other strong citrus or pepper, or bitter cherries, and the like, and any combination thereof, can be added to act as a pet and child deterrent and safety agent in order to prevent ingestion of significant quantities which may prove harmful in selected applications for children, elderly, pets, and the like.

Products such as store bought ice cream (in pint, quart, ½ gallon sizes, and the like) can stay at approximately 6 to approximately 9 F in a soft emulsion state perfect for consumption (though not in a soft serve state). The state can be between a not melted state and a not frozen hard state. The products that as store bought ice cream can be kept in a consistent emulsion state in most outdoor temperature settings between approximately 60 F to approximately 90 F for approximately 8 to approximately 12 hours or longer depending on the type of cooler and amount of ice used with the aqueous solution.

The chilled beer (or other beverages) submerged in the SWIM will remain at optimal temperatures for 8 to 12 hours or more. The beer will remain in a liquid state near or slightly below (or above) it's freezing point without freezing hard, and at up to 10 degrees below the freezing point of water (32 F). This temperature provides an optimal crispness and flavor as well as allowing the beverage to remain colder, longer during consumption. The temperatures of 22 F to 24 F are not generally low enough to cause the beer to ‘slush’ (nucleate) when opened, thereby providing the lowest possible liquid drinking temperatures for beer.

Desert products can be used with the invention, such as but not limited to store bought ice cream, gelatos, popsicles (frozen or unfrozen) submersed in the pre-chilled solution.

The term “approximately” or “approx.” can include +/−10 percent of the number adjacent to the term.

Although the invention references desserts such as ice-cream, other types of edible foods can be used, such as but not limited frozen yogurt, sorbet, sherbet, ice milk, smoothies, milk shakes, and the like, which prevents melting or hard freezing of the foods. Other types of foods can be used with the invention, such as but not limited to fish, meat, poultry, and the like.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

We claim:

1. A liquid composition for use with rapidly chilling beverage containers, comprising:
deionized water;
magnesium chloride;
magnesium citrate; and
vegetable glycerin, wherein the composition is useful as pre-chilled liquid mixture for rapidly chilling beverage containers.

2. The liquid composition of claim 1, further comprising:
a taste modifier.

3. The liquid composition of claim 2, wherein the taste modifier Stevia RebA Aspartane.

4. The liquid composition of claim 1, further comprising:
a defoamer concentrator.

5. The liquid composition of claim 4, wherein the defoamer concentrator includes xiameter.

6. The liquid composition of claim 2, further comprising:
a defoamer concentrator.

7. The liquid composition of claim 6, wherein the taste modifier includes Stevia RebA Aspartane, and the defoamer concentrator includes xiameter.

8. The liquid composition of claim 1, further comprising:
approximately 60% to approximately 80% deionized water;
approximately 10% to approximately 30% magnesium chloride;
less than approximately 1% magnesium citrate; and
less than approximately 5% vegetable glycerin.

9. The liquid composition of claim 8, further comprising:
approximately 70% to approximately 80% deionized water;
approximately 15% to approximately 25% magnesium chloride;
less than approximately 0.5% magnesium citrate; and
less than approximately 2.5% vegetable glycerin.

10. The liquid composition of claim 9, further comprising:
approximately 78.9476 deionized water;
approximately 20.6064 magnesium chloride;
less than approximately 0.0310% magnesium citrate; and
less than approximately 1.2214% vegetable glycerin.

11. The liquid composition of claim 8, further comprising:
less than approximately 5% taste modifier; and
less than approximately 5% defoamer concentrator.

12. The liquid composition of claim 8, further comprising:
less than approximately 2.5% taste modifier; and
less than approximately 2.5% defoamer concentrator.

13. A method of mixing a chilling coolant for beverage containers, comprising the steps of:
providing a first vessel;
adding a first batch of deionized water to the first vessel;
mixing magnesium chloride with the deionized water to form a first homogenous mixture;
allowing the first homogenous mixture to de-aerate in the main vessel;
providing a second vessel;
adding a second batch of deionized water to the second vessel;
heating and mixing the deionized water in the second vessel;
mixing magnesium citrate into the second vessel to form a second homogenous mixture;
allowing the second homogenous mixture to de-aerate in the second vessel;
mixing the second homogenous mixture and the first homogenous mixture together until the two mixtures are homogenous in a combined mixture.

14. The method of claim 13, further comprising the steps of:
mixing additional materials into the combined mixture;
allowing the combined mixture mixed with the added addition materials to de-aerate and cool to room temperature.

15. The method of claim 14, wherein the additional materials are selected from at least one of a taste modifier and a defoamer concentrator.

16. The method of claim 15, wherein the taste modifier includes Stevia RebA Aspartane, and the defoamer concentrator includes xiameter.
